(19) United States
(12) Patent Application Publication
(10) Pub. No.: US 2025/0296443 A1
(43) Pub. Date: Sep. 25, 2025

(54) VISUAL GADGET MANAGEMENT SYSTEM

(71) Applicant: Rivian IP Holdings, LLC, Irvine, CA (US)

(72) Inventors: Fai YEUNG, Palo Alto, CA (US); Michael Adkins KNOTT, San Mateo, CA (US); Meng XU, San Jose, CA (US); Natalija KOKIC, Belgrade (RS); Branislav JEVTIC, Belgrade (RS)

(21) Appl. No.: 19/086,917

(22) Filed: Mar. 21, 2025

Related U.S. Application Data
(60) Provisional application No. 63/568,977, filed on Mar. 22, 2024.

(51) Int. Cl. B60K 35/81; B60K 35/65

(52) U.S. Cl. CPC B60K 35/81; B60K 35/65; B60K 2360/11; B60K 2360/169; B60K 2360/731

(57) ABSTRACT

In certain embodiments, a method of dynamically integrating vehicle-generated video and metadata. The method includes initiating playback of a video file in a display area. The video file includes recorded video in association with vehicle metadata of a plurality of vehicle metadata types. The method also includes determining priorities of a plurality of visual gadgets responsive to the initiated playback, where the plurality of visual gadgets are each associated with at least one vehicle metadata type of the plurality of vehicle metadata types. The method also includes selecting a subset of the plurality of visual gadgets based on the determined priorities. The method also includes causing the selected subset of the plurality of visual gadgets to be placed in the display area, each placed visual gadget of the subset graphically presenting at least a portion of the vehicle metadata of the associated at least one vehicle metadata type.

### CROSS-REFERENCE TO RELATED APPLICATIONS

This application claims priority to and benefit of U.S. Provisional Patent Application No. 63/568,977, filed Mar. 22, 2024, which is assigned to the assignee hereof and hereby expressly incorporated herein in its entirety as if fully set forth below and for all applicable purposes.

### INTRODUCTION

The present disclosure relates to a visual gadget management system.

### SUMMARY

In certain embodiments, one general aspect includes a method of dynamically integrating vehicle-generated video and metadata. The method includes initiating playback of a video file in a display area. The video file includes recorded video in association with vehicle metadata of a plurality of vehicle metadata types. The method also includes determining priorities of a plurality of visual gadgets responsive to the initiated playback, where the plurality of visual gadgets are each associated with at least one vehicle metadata type of the plurality of vehicle metadata types. The method also includes selecting a subset of the plurality of visual gadgets based on the determined priorities. The method also includes causing the selected subset of the plurality of visual gadgets to be placed in the display area, each placed visual gadget of the subset graphically presenting at least a portion of the vehicle metadata of the associated at least one vehicle metadata type.

In certain embodiments, another general aspect includes a system for dynamically integrating vehicle-generated video and metadata. The system includes a memory having executable instructions and a processor in communication with the memory. The processor is configured to execute the instructions to initiate playback of a video file in a display area. The video file includes recorded video in association with vehicle metadata of a plurality of vehicle metadata types. The processor is further configured to execute the instructions to determine priorities of a plurality of visual gadgets responsive to the initiated playback, where the plurality of visual gadgets are each associated with at least one vehicle metadata type of the plurality of vehicle metadata types. The processor is further configured to execute the instructions to select a subset of the plurality of visual gadgets based on the determined priorities. The processor is further configured to execute the instructions to cause the selected subset of the plurality of visual gadgets to be placed in the display area, each placed visual gadget of the subset graphically presenting at least a portion of the vehicle metadata of the associated at least one vehicle metadata type.

In certain embodiments, another general aspect includes a computer-program product including a non-transitory computer-usable medium having computer-readable program code embodied therein. The computer-readable program code is adapted to be executed to implement a method of dynamically integrating vehicle-generated video and metadata. The method includes initiating playback of a video file in a display area. The video file includes recorded video in association with vehicle metadata of a plurality of vehicle metadata types. The method also includes determining priorities of a plurality of visual gadgets responsive to the initiated playback, where the plurality of visual gadgets are each associated with at least one vehicle metadata type of the plurality of vehicle metadata types. The method also includes selecting a subset of the plurality of visual gadgets based on the determined priorities. The method also includes causing the selected subset of the plurality of visual gadgets to be placed in the display area, each placed visual gadget of the subset graphically presenting at least a portion of the vehicle metadata of the associated at least one vehicle metadata type.

### BRIEF DESCRIPTION OF THE DRAWINGS

FIG. 1A illustrates an example vehicle that may be operated in accordance with certain embodiments.

FIG. 1B illustrates a chassis of a vehicle having multiple drive units that may be operated in accordance with certain embodiments.

FIG. 2A is a schematic block diagram of a control system of a vehicle in accordance with certain embodiments.

FIG. 2B is a schematic block diagram of an alternative control system of a vehicle in accordance with certain embodiments.

FIG. 3 illustrates an example of a visual gadget management system in accordance with certain embodiments.

FIG. 4 illustrates an example of a user interface that can be provided by the visual gadget management system of FIG. 3 in accordance with certain embodiments.

FIG. 5 illustrates an example of a process for automatic prioritized placement of visual gadgets in accordance with certain embodiments.

FIG. 6 illustrates an example of a process for dynamically integrating vehicle-generated video and metadata during video playback, in accordance with certain embodiments.

FIG. 7 illustrates an example of a display area that includes an output of a virtual tour overlay module, in accordance with certain embodiments.

FIGS. 8A and 8B illustrate examples of trip route gadgets in accordance with certain embodiments.

FIGS. 9-11 illustrates additional examples of trip route gadgets in accordance with certain embodiments.

FIG. 12 illustrates an example of a display area that includes a seek bar.

FIG. 13 illustrates an example of a seek bar.

FIG. 14 illustrates an example of a nodal graph that can be created and updated by a self-learning recommendation engine.

### DETAILED DESCRIPTION

A vehicle may include a system that provides video recording and playback, for example, as part of an infotainment application. The system may periodically record, for example, video of a vehicle's surroundings as the vehicle travels (e.g., based on an event, a vehicle mode, a user command, etc.). Typically, however, vehicle metadata such as, for example, speed, G-force, elevation and location, is lost after the video is recorded. Although vehicle metadata could enhance the context and understanding of recorded video, such metadata is usually disconnected from the recorded video and thus, as a general matter, cannot be easily reviewed along with the recorded video. Therefore, when users access playback functionality, they are typically presented with video footage that is devoid of any accompanying vehicle metadata such as speed, G-force, elevation, location and/or the like.

In certain aspects, to address the above problem, selected vehicle metadata (e.g., the foregoing examples of vehicle metadata) can be included as metadata in a video file. The video file can utilize a predetermined file format such as, for example, the MP4 file format. In some aspects, inclusion in this manner can provide access to vehicle metadata during video playback. However, even still, it is technically challenging to optimize a user experience for displaying the vehicle metadata along with recorded video. For example, there is typically limited screen real estate during video playback, such as playback that may occur on an infotainment display of the vehicle. There may not be sufficient space to display all of the vehicle metadata. Furthermore, displaying an abundance of vehicle metadata may obscure video or other data and/or be confusing to users.

The issue of limited screen real estate might be partially addressed by the system displaying only a portion of the vehicle metadata. For example, a predetermined selection of the vehicle metadata could be shown in a fixed position during video playback. However, under such approaches, users would be unable to control the selection and placement of the vehicle metadata. Accordingly, such approaches would offer little flexibility for customization or adaptation, for example, based on individual preferences or the dynamics of a given video. Users would be limited in their ability to leverage potential insights and context provided by the vehicle metadata, thus leading to a suboptimal user experience and diminished utility.

The present disclosure describes examples of a visual gadget management system (VGMS) for dynamically integrating vehicle-generated video and metadata. The VGMS can include, for example, a vehicle system executing a video player. The video player can maintain a plurality of visual gadgets that can be variably selected and placed in a display area provided by the video player, such as a customizable tray interface. In certain aspects, each visual gadget can be, for example, a user interface container that is configured to graphically present at least one type of vehicle metadata associated therewith. Visual gadgets can include, for example, data, images, graphs, animations and/or the like that dynamically illustrate vehicle metadata of the associated types of vehicle metadata in correlation to recorded video.

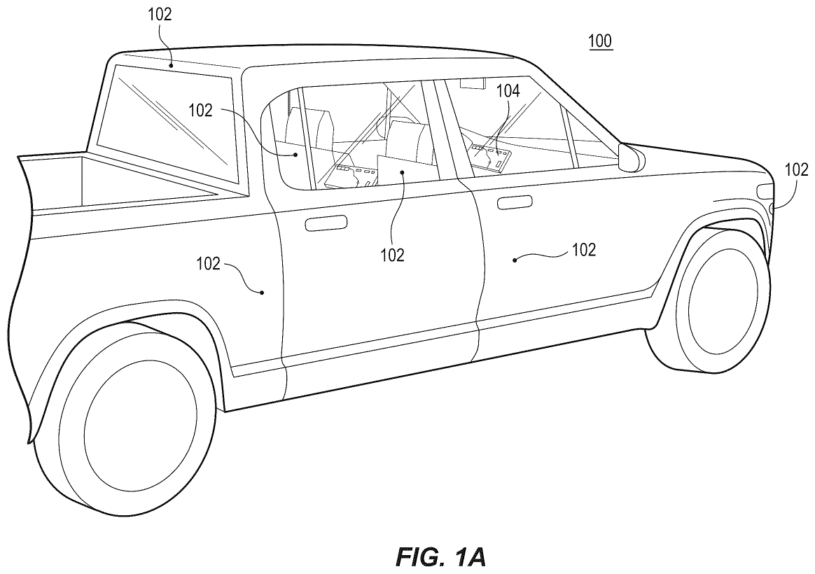

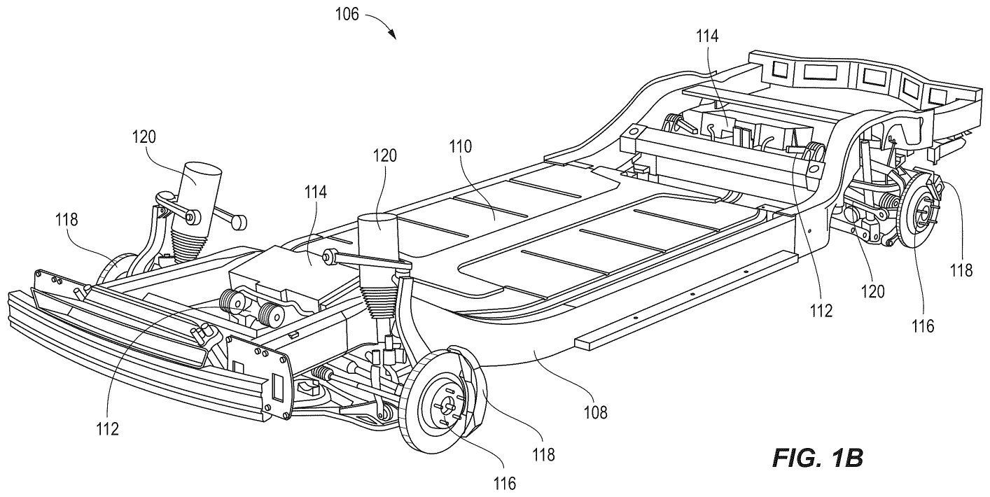

In various aspects, the VGMS can implement a contextual prioritization algorithm that intelligently curates the selection and placement of visual gadgets within the display area. Further, in various aspects, the VGMS can provide, as visual gadgets, virtual tour overlays that leverage global positioning system (GPS) data and artificial intelligence (AI)-driven computer vision to annotate points of interest in real-time or via post-processing, thereby enriching the viewing experience with augmented reality elements. Additionally, in some aspects, the VGMS can implement and provide contextual route-based gadgets, thereby enabling users to navigate through video content based on their preferences and interests, with programmable behaviors enhancing usability and relevance. Various aspects can also incorporate a personalized learning mechanism, which adapts to individual user preferences across various vehicle modes and/or driving conditions, thereby ensuring tailored and intuitive gadget recommendations for an immersive playback experience. Examples will be described relative to FIGS. 1A-B, 2A-B, 3-7, 8A-B, and 9-14.

FIG. 1A illustrates an example vehicle 100. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by power electronics 114 of each drive unit 112. The power electronics 114 may include inverters configured to convert direct current (DC) from the battery 110 into alternating current (AC) supplied to the motors of the drive units 112. The power electronics 114 further facilitate operation of the motors of the drive units as generators to provide regenerative braking. The power electronics 114 further facilitate the transfer of regenerative current to the battery 110.

The drive units 112 are coupled to two or more hubs 116 to which wheels may mount. Each hub 116 includes a corresponding brake 118, such as the illustrated disc brakes. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that may have a portion that is idled during some modes of operation. For example, a front or rear differential of an all-wheel drive vehicle. In another example, in a hybrid drive train, an idled drive unit including an electric motor may be heated with waste heat from an ICE according to the approaches described herein.

FIG. 1A illustrates an example vehicle 100. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear reduction drive. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by one or more sets of power electronics 114. The power electronics 114 may include inverters configured to convert direct current (DC) from the battery 110 into alternating current (AC) supplied to the motors of the drive units 112.

The drive units 112 are coupled to two or more hubs 116 to which wheels may mount. Each hub 116 includes a corresponding brake 118, such as the illustrated disc brakes. The drive units 112 or other component may also provide regenerative braking. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that requires heating in preparation for use, such as diesel engines.

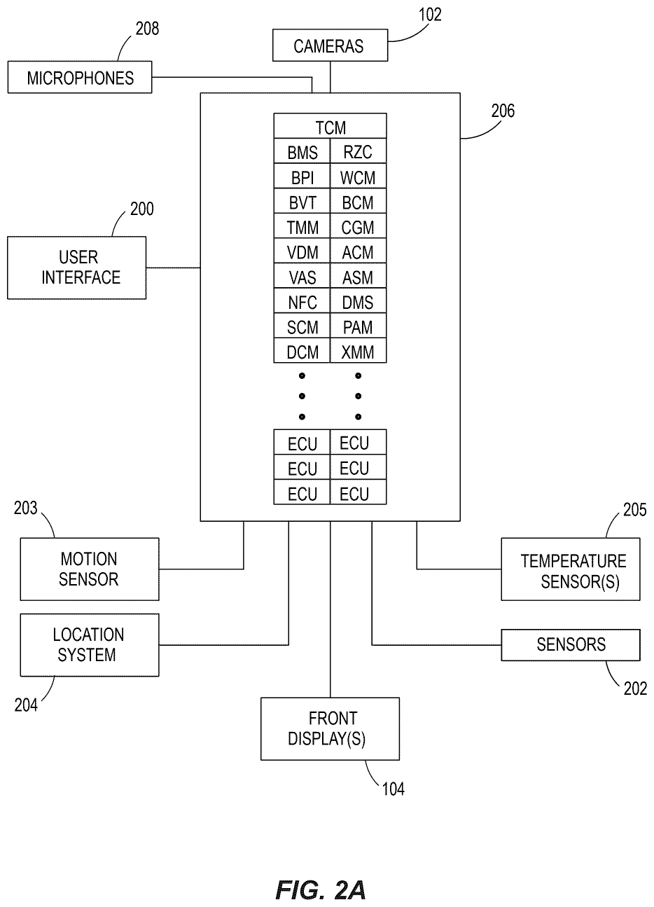

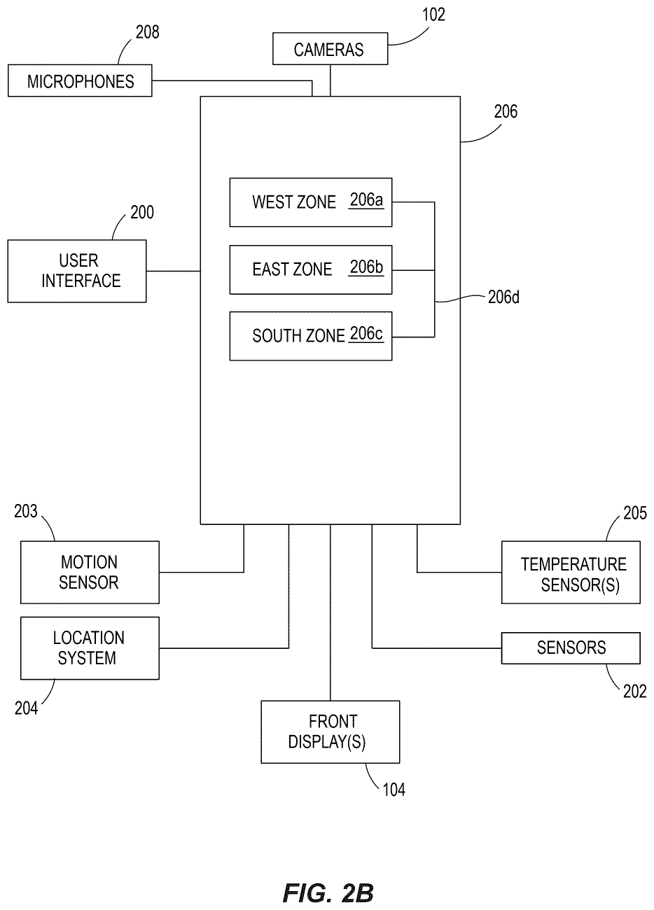

FIG. 2A illustrates example components of the vehicle 100 of FIG. 1A. As shown in FIG. 2A, the vehicle 100 includes the exterior cameras 102, the one or more front displays 104, a user interface 200, one or more sensors 202, a motion sensor 203, and a location system 204. The one or more sensors 202 may include ultrasonic sensors, radio detection and ranging (RADAR) sensors, light detection and ranging (LIDAR) sensors, or other types of sensors. The location system 204 may be implemented as a global positioning system (GPS) receiver and may also include an inertial measurement unit (IMU) (e.g., accelerometers). The user interface 200 allows a user, such as a driver or passenger in the vehicle 100, to provide input.

The components of the vehicle 100 may include one or more temperature sensors 205. The temperature sensors 205 may include sensors configured to sense an ambient air temperature, temperature of the battery 110, temperature of power electronics 114, temperature of each drive unit 112 and/or each motor of each drive unit 112, or the temperature of any other component of the vehicle 100.

A control system 206 executes instructions to perform at least some of the actions or functions of the vehicle 100, including the functions described below. For example, as shown in FIG. 2, the control system 206 may include one or more electronic control units (ECUs) configured to perform at least some of the actions or functions of the vehicle 100, including the functions described below. In certain embodiments, each of the ECUs is dedicated to a specific set of functions. Each ECU may be a computer system and each ECU may include functionality described below.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle's communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102 and sensors 202. The sensor signals collected by the CGM ECU are then communicated to the appropriate ECUs for performing, for example, the operations and functions described below.

The control system 206 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU. If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 208, etc.) to the TCM ECU.

Referring to FIG. 2B, in some embodiments, the control system 206 may be implemented as a plurality of zonal controllers 206a, 206b, 206c. Each zonal controller 206a, 206b, 206c may control a subset of systems of the vehicle. The subset of systems controlled by each zonal controller 206a, 206b, 206c may be generally assigned based on location within the vehicle 100. For example, a west zonal controller 206a may control systems on a driver side of the vehicle 100, an cast zonal controller 206b may control systems on a passenger side of the vehicle 100, and a south zonal controller 206c may control systems in a rear portion of the vehicle. Each zonal controller 206a, 206b, 206c may implement a portion of the functions ascribed to the ECUs of the control system 206 of FIG. 2A. The functions of the ECUs may be distributed among the zonal controller 206a, 206b, 206c such that only one zonal controller 206a, 206b, 206c implements the functions of each ECU. Alternatively, the functions of an ECU may be duplicated across multiple zonal controllers 206a, 206b, 206c, each zonal performing the functions of the ECU for the portion of the vehicle to which that zonal controller 206a, 206b, 206c is assigned.

The zonal controllers 206a, 206b, 206c may be connected to one another by a network 206d, such as an Ethernet network, controller area network (CAN), or other type of network.

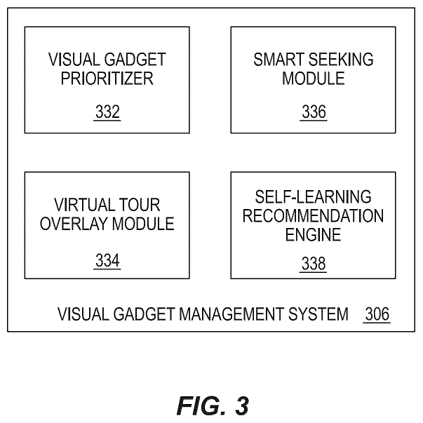

FIG. 3 illustrates an example of a VGMS 306 operable to manage visual gadgets in accordance with certain embodiments. In various aspects, the VGMS 306 may be, or can include, any system operable to provide playback of recorded video for a vehicle (e.g., the vehicle 100). For example, in some aspects, the VGMS 306 can be implemented by an ECU of the control system 206 of FIGS. 2A-B, such as the XMM ECU discussed relative to FIG. 2B. The VGMS 306 includes a visual gadget prioritizer 332, a virtual tour overlay module 334, a smart seeking module 336, and a self-learning recommendation engine 338, each of which can be implemented, for example, by a video player software application executing on the VGMS 306.

More generally, the VGMS 306 can maintain a set of visual gadgets and, in certain aspects, can categorize the visual gadgets into distinct groups, such as pinned, managed, and hidden. Pinned gadgets can correspond, for example, to visual gadgets explicitly set by a user, thereby allowing for personalized customization and arrangement. Managed gadgets can correspond, for example, to visual gadgets controlled by the visual gadget prioritizer 332 (further discussed below), which gadgets can be automatically and dynamically adjusted based on contextual cues and user interactions. Hidden gadgets can correspond, for example, to visual gadgets that are not made available for customization or arrangement, for example, because no vehicle metadata associated with the gadgets is currently available.

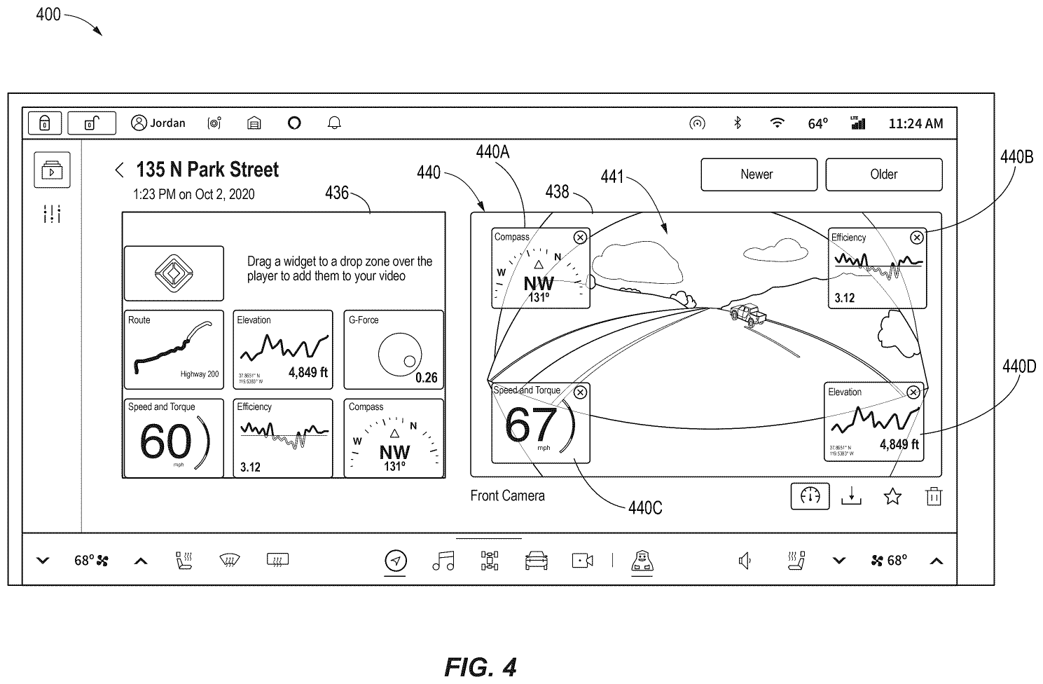

In certain aspects, the VGMS 306 is operable to provide one or more user interfaces for providing and customizing a display area. The display area provided by the VGMS 306 can include, for example, recorded video and a tray of visual gadgets that each supply vehicle metadata related to the recorded video. In certain aspects, the visual gadget tray can be organized into a grid (e.g., a grid of squares), with gadgets occupying predefined or arbitrary sizes to accommodate various types of vehicle metadata. In certain aspects, variants of visual gadgets, such as different sizes or visual styles, can further enhance flexibility and customization options. Additionally, background colors for visual gadgets can be selected based on predefined themes, user preferences, or contextual factors determined by the prioritization algorithm, ensuring a cohesive and visually appealing interface tailored to the user's preferences and driving environment. An example of a user interface provided by the VGMS 306 will be discussed relative to FIG. 4.

The visual gadget prioritizer 332 can implement a context-based prioritization algorithm to intelligently manage the selection and arrangement of visual gadgets within the display area. The visual gadget prioritizer 332 can utilize, for example, machine learning methodologies. In addition, or alternatively, the visual gadget prioritizer 332 can operate by defining a cost function and leveraging, for example, Bayesian modeling, in consideration of various factors such as personal preferences, vehicle modes, and real-time vehicle metadata. Visual gadgets can be represented as nodes within a priority tree, with each node assigned a priority score based on its relevance and importance within the given context. Through iterative optimization using the cost function, the algorithm dynamically adjusts the priority order of nodes to ensure the most pertinent visual gadgets are presented prominently in the tray interface.

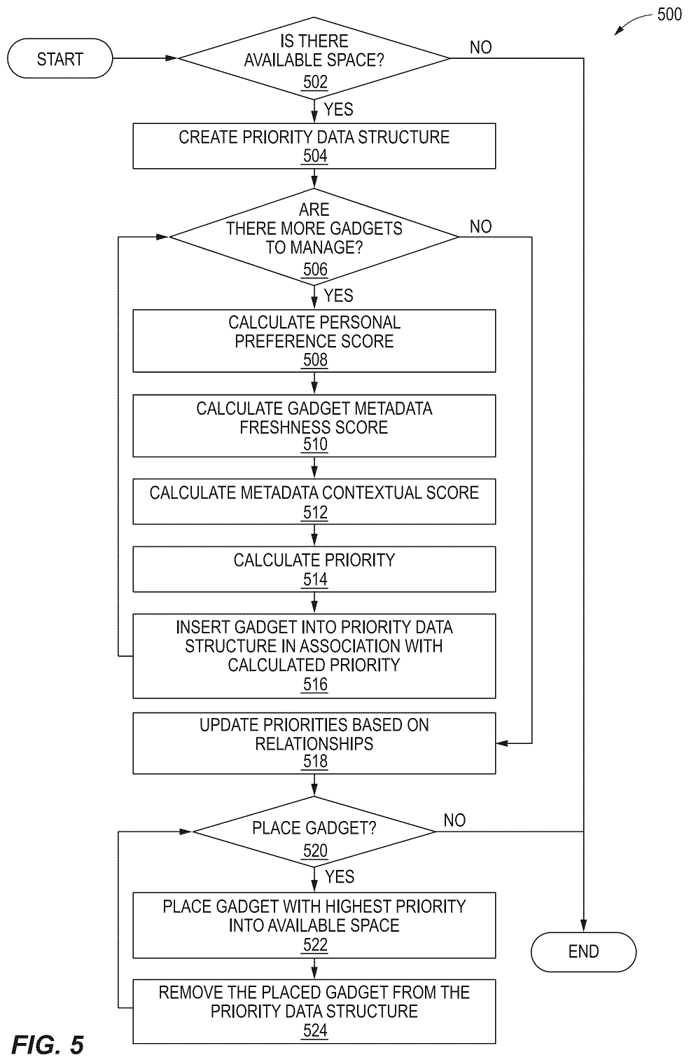

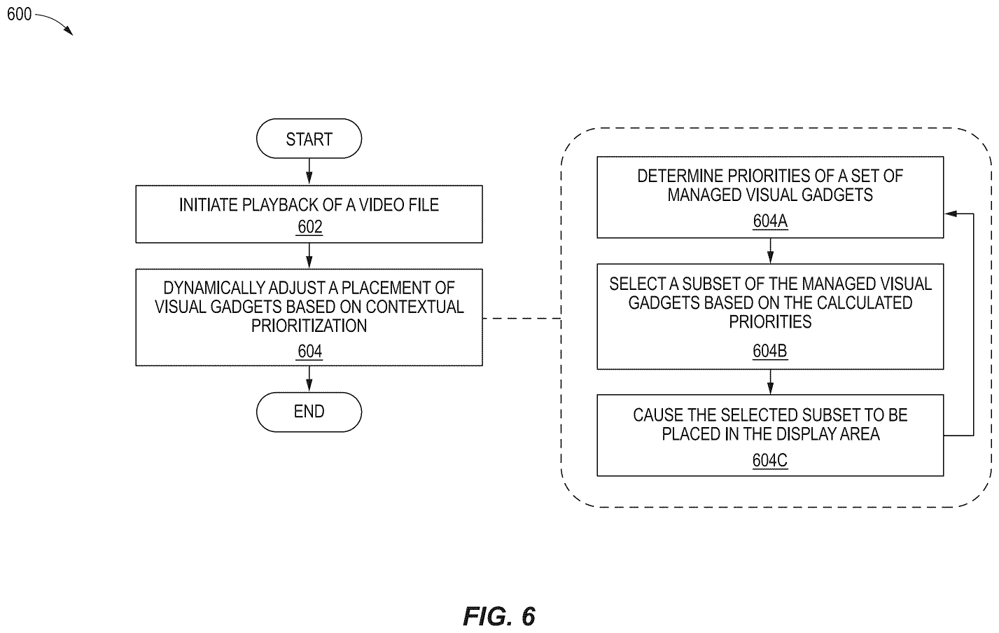

In certain aspects, the visual gadget prioritizer 332 can not only determine which visual gadgets to display but may also govern their placement within the visual gadget tray. For instance, gadgets deemed more crucial or frequently accessed may be positioned prominently on the left side of the screen, offering optimal visibility to the driver. Additionally, the visual gadget prioritizer 332 can incorporate mechanisms to regulate the swapping of gadgets, ensuring a balanced and coherent display experience. For example, the visual gadget prioritizer 332 can employ strategies to prevent excessive gadget swapping, thereby maintaining stability and consistency in visual presentation. Example operation of the visual gadget prioritizer 332 will be discussed in greater detail relative to FIGS. 5 and 6.

The virtual tour overlay module 334 can be, or can supply, a visual gadget providing a virtual tour function within the VGMS 306. In certain aspects, the virtual tour overlay module 334 can leverage global positioning system (GPS) location data and computer vision technology to dynamically identify and annotate points of interest (POIs) in the display area. The POIs can be dynamically identified, for example, along the selected route in real-time and/or during post-processing.

In certain aspects, the virtual tour overlay module 334 can employ machine learning techniques such as convolutional neural networks (CNNs) to analyze visual data from onboard cameras (e.g., the exterior cameras 102 discussed above) or decoded video frames in video files (e.g., MP4 files). In this way, the virtual tour overlay module 334 can recognize distinctive features and patterns, associated, for example, with various landmarks and other POIs. In addition, or alternatively, the virtual tour overlay module 334 can use object detection algorithms, such as You Only Look Once (YOLO) or Single Shot MultiBox Detector (SSD), to robustly identify and localize POIs within the video frames, in some cases generating bounding boxes around these objects.

In some aspects, the virtual tour overlay module 334 can employ various smoothing techniques, such as Kalman filtering or exponential moving averages, to predict and interpolate the positions of bounding boxes across successive frames. Advantageously, in certain aspects, such smooth techniques can maintain temporal consistency and minimize computational overhead.

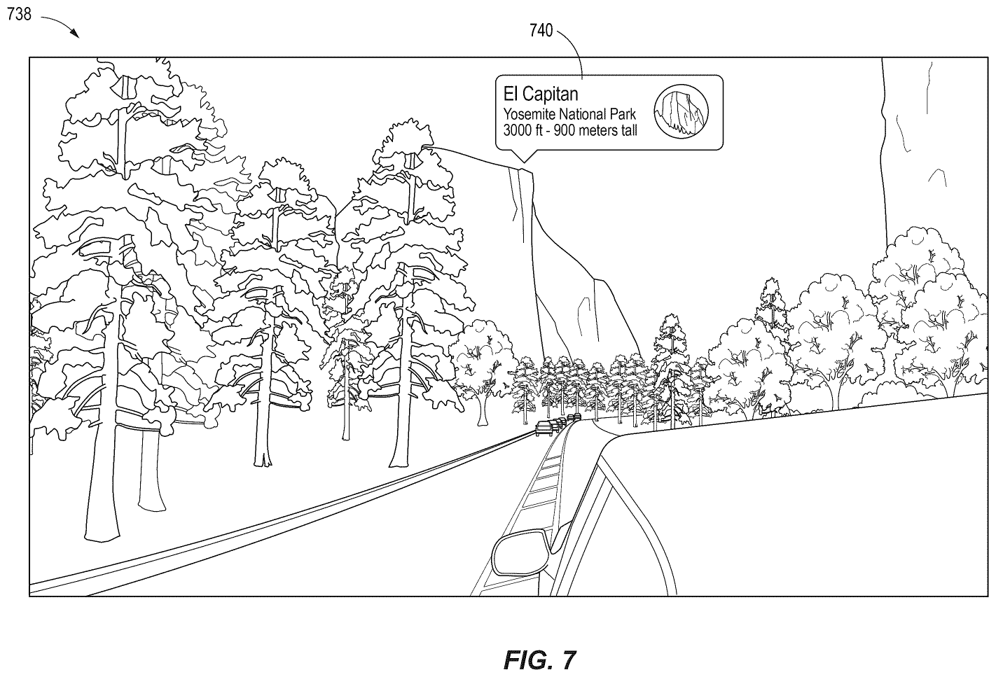

In certain aspects, the virtual tour overlay module 334 can use one or more of the methodologies discussed above to recognize various types of POIs including, for example, iconic landmarks (e.g., Half Dome in Yosemite or the Golden Gate Bridge in San Francisco), user-favorite businesses, interactive identification games, and historically significant areas. In certain aspects, through a fusion of GPS data, computer vision, and machine learning techniques, the virtual tour overlay module 334 can offer users an enriched and educational driving experience, seamlessly blending digital annotations with real-world surroundings to create captivating journeys filled with discovery and engagement. Example output of the virtual tour overlay module 334 will be discussed relative to FIG. 7.

The smart seeking module 336 can be, or can supply, one or more visual gadgets for visualizing and navigating recorded video. In certain aspects, the smart seeking module 336 can go beyond metadata visualization by integrating trip-related data such as stops, speed patterns, and battery consumption into an interactive map display. In certain aspects, by leveraging object recognition metadata or sematic mapping information, the smart seeking module 336 can enhance the user's understanding of a recorded journey by highlighting significant points of interest such as wildlife sightings, forested areas, or bodies of water directly on the map.

In addition, or alternatively, the smart seeking module 336 can be, or can include, a seek bar interface to which seek checkpoints can be added based on any of the data described herein, such as the vehicle metadata, POIs, trip-related data, and/or the like. In certain aspects, the seek checkpoints can help the user quickly seek to video associated with events of interest during a given drive. The seek checkpoints can be displayed, for example, as small stickers above a seek bar. In certain aspects, selecting a seek checkpoint (e.g., by long-pressing a sticker) can result in a summary of an associated event of interest at that moment in the video. The summary can include, for example, a category, name, playback time, description, and/or other data. Further, in certain aspects, the position of each seek checkpoint (e.g., a position of sticker) can indicate a point on the seek bar where user should click to seek to video of the associated event of interest.

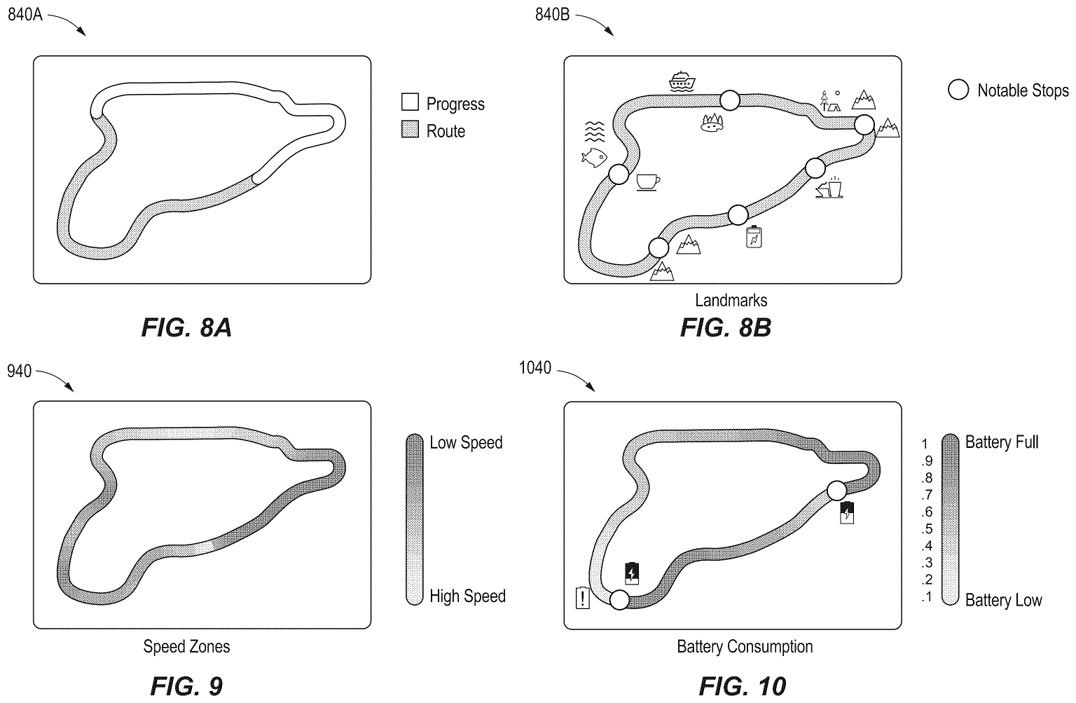

Advantageously, in certain aspects, the seek bar interface provided by the smart seeking can allow users to easily jump to interesting events that occurred during the video (e.g., highlights from a drive). In these aspects, the seek bar interface can improve user experience by providing quick access to key moments in the video. Example output of the smart seeking module 336 will be discussed relative to FIGS. 8A-B, 9-10, and 11-13.

In certain aspects, the self-learning recommendation engine 338 represents a sophisticated approach to understanding and adapting to users' preferences for visual gadgets, for example, within specific vehicle modes. For example, by studying user interactions and choices, the self-learning recommendation engine 338 can tailor recommendations for visual gadgets based on vehicle modes such as off-roading, sports, sand, snow, camping, and more. Users can have the flexibility to dismiss suggested gadgets, allowing the algorithm to learn and refine its recommendations over time.

In various aspects, the self-learning recommendation engine 338 can utilize a graph-based representation to visualize the learning process of user choices for each vehicle mode. In this connected nodal graph, each node can represent a visual gadget, and the lines connecting between nodes depict the frequency of selection between two gadgets. For example, if a user frequently selects a launch mode, there may be strong connections to related gadgets such as the speedometer or G-force meter, indicating a correlation between user preferences for these gadgets during high-performance driving scenarios.

As an example of how the self-learning recommendation engine 338 could function, consider a user engaging in sports mode. Initially, the self-learning recommendation engine 338 may suggest a set of visual gadgets tailored for this vehicle mode, including a performance dashboard displaying metrics such as speed, acceleration, and G-forces. As the user interacts with these gadgets, the self-learning recommendation engine 338 can observe their behavior (e.g., selections) and adjust its recommendations accordingly. If, for example, the user consistently dismisses certain gadgets while frequently selecting others, the self-learning recommendation engine 338 can update the connections within the nodal graph to reflect these preferences. Over time, the self-learning recommendation engine 338 can refine its recommendations to better align with the user's individual preferences and driving habits, enhancing the overall user experience and engagement with the infotainment system.

Advantageously, in certain aspects, through this iterative process of learning and adaptation, the self-learning recommendation engine 338 can empower users to seamlessly customize their video playback experience based on their unique preferences and driving conditions. For example, by leveraging connected nodal graphs to visualize and analyze user interactions, the self-learning recommendation engine 338 continuously evolves its recommendations, ensuring a personalized and intuitive interface tailored to each user's needs and preferences. An example of a nodal graph that can be used and updated by the self-learning recommendation engine 338 will be described relative to FIG. 14.

FIG. 4 illustrates an example of a user interface 400 that can be provided by the VGMS 306 of FIG. 3 in accordance with certain embodiments. The VGMS 306 includes a gadget library 436 and a display area 438. The gadget library 436 can include, for example, a collection of visual gadgets that can be selected and dragged to the display area 438 for manual placement by a user. The display area 438 includes a visual gadget tray 440 translucently overlaid on recorded video 441. For illustrative purposes, the visual gadget tray 440 is shown to include visual gadgets 440A, 440B, 440C, and 440D. It should be appreciated, however, that the visual gadget tray 440 can include any suitable number or placement of visual gadgets.

FIG. 5 illustrates an example of a process 500 for automatic prioritized placement of visual gadgets in accordance with certain embodiments. In certain aspects, the process 500 can be executed at the beginning of playback of a video file that includes recorded video. In addition, or alternatively, the process 500 can be executed continuously by the VGMS 306, for example, at any suitable interval during playback of a recorded video. In certain aspects, the process 500 can be implemented by any vehicle system that can process data. Although any number of systems, in whole or in part, can implement the process 500, to simplify discussion, the process 500 will be described primarily in relation to the visual gadget prioritizer 332 of FIG. 3.

At decision block 502, the visual gadget prioritizer 332 determines whether a display area provided by the VGMS 306 has available space for any managed visual gadgets. As discussed previously, the display area can include, for example, recorded video in relation to a visual gadget tray. In some aspects, the visual gadget tray can be translucently overlaid on the recorded video. The display area can be similar, for example, to the display area 438 of FIG. 4.

If it is determined, at the decision block 502, that the display area has no available space for managed visual gadgets (e.g., because pinned gadgets take up all available space in the visual gadget tray), the process 500 can end. Otherwise, if it is determined, at the decision block 502, that there is available space in the display area provided by the VGMS 306, the process 500 proceeds to block 504. At block 504, the visual gadget prioritizer 332 creates a priority data structure such as a tree, queue, and/or the like.

At decision block 506, the visual gadget prioritizer 332 determines whether there are more visual gadgets to manage. In certain aspects, the visual gadget prioritizer 332 iteratively executes blocks 508-516 to score or evaluate each visual gadget in a set of managed visual gadgets. According to these aspects, the visual gadget prioritizer 332 can reach an affirmative determination at the decision block 506 if there are visual gadgets in the set that have not yet been scored or evaluated during a present iteration of the process 500. According to these aspects, the visual gadget prioritizer 332 can otherwise reach a negative determination at the decision block 506. If the visual gadget prioritizer 332 reaches a negative determination at the decision block 506, the process 500 can proceed to block 518 (discussed further below). If the visual gadget prioritizer 332 reaches an affirmative determination at the decision block 506, the process 500 proceeds to execute blocks 508-516 for a visual gadget in the set (e.g., the next visual gadget in the set of managed visual gadgets according to any suitable order of processing).

At block 508, the visual gadget prioritizer 332 calculates a personal preference score for the visual gadget based on user preference in relation to the visual gadget. In some aspects, the personal preference score can be based on user preferences for visual gadgets within specific vehicle modes (e.g., road driving mode, parked mode, off-roading mode, tow mode, camping mode, etc.). For example, the personal preference score can be determined based on a graph representation developed by the self-learning recommendation engine 338, as discussed above relative to FIG. 3 and below relative to FIG. 14. In addition, or alternatively, the personal preference score can be determined based on express user preferences for visual gadgets within specific vehicle modes, such as a ranking of the set for different vehicle modes. For example, the personal preference score can be the rank of the visual gadget, or a value based on the rank. Other examples of calculating the personal preference score will be apparent to one skilled in the art after a detailed review of the present disclosure.

At block 510, the visual gadget prioritizer 332 calculates a gadget metadata freshness score for the visual gadget. The gadget metadata freshness score can be based on an amount by which metadata for the visual gadget has changed over a predetermined interval of the recorded video, or over a predetermined interval of an event represented by the recorded video. The predetermined interval of time can be, for example, an immediately preceding period (e.g., the preceding 5 seconds, 10 seconds, etc.), a period since the last calculation of the gadget metadata freshness score, and/or the like. In some aspects, the gadget metadata freshness score can correspond to an amount of fluctuation in one or more values, an amount of increase or decrease, an indication of whether one or more elements of metadata have new or different values, and/or the like.

At block 512, the visual gadget prioritizer 332 calculates a metadata contextual score for the visual gadget. The metadata contextual score can be an indicator of a current relevance of the visual gadget, or of the metadata associated therewith, based on contextual data such as, for example, time, weather, location, vehicle mode, and/or the like. In certain aspects, different values of the contextual data can be associated with different intermediate scores that are summed, for example, to calculate the metadata contextual score.

At block 514, the visual gadget prioritizer 332 calculates a priority of the visual gadget based on the personal preference score, the gadget metadata freshness score, and the metadata contextual score. In some aspects, the priority can be an aggregate of the personal preference score, the gadget metadata freshness score, and the metadata contextual score (e.g., a sum, mean, median, etc.). In addition, or alternatively, the personal preference score, the gadget metadata freshness score, and/or the metadata contextual score can be weighted in any suitable fashion to calculate the priority.

At block 516, the visual gadget prioritizer 332 inserts the visual gadget into the priority data structure in association with the calculated priority. From block 516, the process 500 returns to decision block 506 and executes as described above. The process 500 can continue to iterate through blocks 506-516 until each visual gadget in the set of managed visual gadget has been inserted into the priority data structure with a calculated priority, at which point a negative determination is reached at the decision block 506, as discussed above, and the process 500 proceeds to block 518.

At block 518, the visual gadget prioritizer 332 can update the priorities in the priority data structure based on relationships between visual gadgets of the set of managed visual gadgets. For example, certain subsets of visual gadgets may be deemed beneficial to use together in certain vehicle modes, with the subsets being different for different vehicle modes. In an example, in a sports mode, visual gadgets for speed, acceleration, and G-forces may be used together. In certain aspects, based on a current vehicle mode, the visual gadget prioritizer 332 can adjust priorities for a subset of the vehicle gadgets that are associated with the current vehicle mode. The priorities can also be updated in other suitable fashions. In some aspects, no updates to the priorities may be performed, in which case the block 518 can be omitted.

At decision block 520, the visual gadget prioritizer 332 determines whether to place a visual gadget in the display area. In certain aspects, the visual gadget prioritizer 332 can reach an affirmative determination at the decision block 520 if, for example, unplaced visual gadgets remain in the priority data structure and space remains in the display area for placement. Otherwise, the visual gadget prioritizer 332 can reach a negative determination at the decision block 520. If the visual gadget prioritizer 332 determines, at the decision block 520, not to place a visual gadget (e.g., due to previous iterations through blocks 520-524), the process 500 can end. Otherwise, the process 500 can proceed to block 522.

At block 522, the visual gadget prioritizer 332 places the visual gadget having the highest priority into the display area. For example, the visual gadget can be placed within a grid of a visual gadget tray, as discussed above. In some aspects, the grid of the visual gadget tray can include a plurality of grid locations associated with a prioritized order of placement (e.g., locations on the left may have higher priority than locations on the right). In these aspects, the first iteration of the block 522 can involve, for example, the highest priority visual gadget in the priority data structure being placed in the highest priority location in the grid (e.g., the highest priority location in which a higher priority visual gadget has not already been placed).

In some aspects, the block 522 can involve swapping one visual gadget for another, for example, by replacing an existing visual gadget with the highest priority visual gadget in the priority data structure. In some of these aspects, the visual gadget being replaced can be moved to a lower priority location in the grid. In certain aspects, swapping can be limited to avoid user confusion. For example, swapping can be limited based on a defined threshold number of swaps during at least a portion of the playback. The defined threshold can be, for example, a threshold number of swaps during playback and/or a threshold number of swaps during an interval of playback (e.g., 5, seconds, 20 seconds, 1 minute, etc.). According to this example, swapping can be performed if an amount of previous gadget swapping is less than an applicable defined threshold.

In some aspects, if the metadata for the visual gadget being placed has changed abruptly (e.g., a new value or a change occurs in excess of a threshold), the visual gadget prioritizer 332 can animate, or cause to be animated, the abrupt change that has already occurred. In some of these aspects, an indication of the abrupt change can be shown for a short interval of time (e.g., 3 seconds) after placing the gadget on the screen before proceeding to display current vehicle metadata corresponding a current portion of playback.

At block 524, the visual gadget prioritizer 332 removes the placed visual gadget from the priority data structure. From block 524, the process 500 returns to decision block 520 and executes as described above. The process 500 can continue to iterate through blocks 520-524, for example, until no space remains in the display area for placement, until no unplaced visual gadgets remain in the priority data structure, or until other suitable termination criteria is satisfied.

FIG. 6 illustrates an example of a process 600 for dynamically integrating vehicle-generated video and metadata during video playback, in accordance with certain embodiments. In certain aspects, the process 600 can be executed in response to a command to begin playback of a video file. In certain aspects, the process 600 can be implemented by any vehicle system that can execute a video player software application. Although any number of systems, in whole or in part, can implement the process 600, to simplify discussion, the process 600 will be described primarily in relation to the VGMS 306 of FIG. 3.

At block 602, the VGMS 306 initiates playback of a video file in a display area provided by the video player. As discussed previously, the video file can include recorded video in association with vehicle metadata of a plurality of vehicle metadata types. The display area can be similar, for example, to the display area 438 of FIG. 4.

At block 604, the VGMS 306, during the playback, dynamically adjusts a placement of visual gadgets in the display area based on contextual prioritization performed, for example, by the visual gadget prioritizer 332. In some aspects, the block 604 can involve, for example, continuously executing the process 500 of FIG. 5 (e.g., on any suitable interval) until the playback ends. For example, in some aspects, as shown, the dynamic adjustment at block 604 can include continuously (e.g., repeatedly) executing blocks 604A, 604B, and 604C until the playback ends.

For example, at block 604A, the VGMS 306 can determine priorities of a set of managed visual gadgets, for example, as discussed relative to blocks 506-518 of FIG. 5. In some aspects, the priorities can correspond to, or be based on, user preference scores, gadget metadata freshness scores, metadata contextual scores, or a combination thereof. As discussed above relative to FIG. 5, the priorities can be represented, for example, in a priority data structure such as a queue or tree.

In certain aspects, blocks 604B and 604C can collectively represent execution, for example, of blocks 520-524 of FIG. 5. At block 604B, the VGMS 306 selects a subset of the managed visual gadgets for placement based on the determined priorities. At block 604C, the VGMS 306 causes the selected subset of the managed visual gadgets to be placed in the display area provided by the video player, such that each placed visual gadget of the subset graphically presents at least a portion of the vehicle metadata of the associated at least one vehicle metadata type. For example, the VGMS 306 can position the selected subset in the display area based on the determined priorities, as discussed relative to FIG. 5.

In certain aspects, the VGMS 306 can iteratively execute blocks 604A, 604B, and 604C during the playback of the video file. In certain aspects, if the determined priorities for a current iteration of blocks 604A-C differ from the determined priorities for an immediately preceding iteration of blocks 604A-C, the block 604C of the current iteration can include, for example, swapping, in the display area, one or more visual gadgets for other visual gadgets (e.g., as discussed above relative to FIG. 5) responsive to the difference. In some aspects, as discussed relative to FIG. 5, the swapping can be performed responsive to a determination that an amount of previous gadget swapping during at least a portion of the playback is less than a defined threshold.

In addition, or alternatively, in some aspects, the selected subset for the current iteration of blocks 604A-C can be the same as the selected subset for the immediately preceding iteration of blocks 604A-C. According to these aspects, the block 604C of the current iteration can include, for example, maintaining an existing placement of the selected subset in the display area. The existing placement may have been implemented, for example, in an earlier iteration of the blocks 604A-C. In some cases, the existing placement may be maintained, for example, responsive to a determination that an amount of previous gadget swapping during at least a portion of the playback is greater than or equal to a defined threshold of the type described above. In addition, or alternatively, the existing placement may be maintained, for example, as a result of there not being a sufficient change to the determined priorities between the immediately preceding iteration of blocks 604A-C and the current iteration of blocks 604A-C (e.g., a priority order of the visual gadgets remains the same).

In certain aspects, blocks 604A-C can continue to iteratively execute, as part of the block 604, until playback is stopped or other suitable termination criteria is satisfied. After block 604, the process 600 ends.

FIG. 7 illustrates an example of a display area 738 that includes an output of the virtual tour overlay module 334, as discussed above relative to FIG. 3, in accordance with certain embodiments. The display area 738 includes a visual gadget 740 that indicates a POI in recorded video.

FIG. 8A illustrates an example of a trip route gadget 840A that can be provided by the smart seeking module 336, as discussed above relative to FIG. 3, in accordance with certain embodiments. In the illustrated example, the trip route gadget 840A graphically presents trip progress.

FIG. 8B illustrates another of a trip route gadget 840B that can be provided by the smart seeking module 336, as discussed above relative to FIG. 3, in accordance with certain embodiments. In the illustrated example, the trip route gadget 840B graphically presents an interactive map display with map markers that indicate certain metadata such as POIs and notable stops.

In certain aspects, the map marker functionality of the trip route gadget 840B can extend beyond mere visualization, serving as a powerful navigation tool for users seeking to navigate through lengthy video recordings. For example, instead of relying on cumbersome linear slider bars or manual scrubbing to move to different points in the recorded video, in various aspects, the map markers can correspond to seek checkpoints in the recorded video. In various aspects, users can simply interact with the map markers to jump to specific time entries or points of interest with a single user input (e.g., a finger touch on a touchscreen). This streamlined navigation process allows users to navigate to the next interesting segment of the video quickly and effortlessly.

FIG. 9 illustrates another example of a trip route gadget 940 that can be provided by the smart seeking module 336, as discussed above relative to FIG. 3, in accordance with certain embodiments. In the illustrated example, the trip route gadget 940 graphically presents an interactive map showing speed patterns or zones during a trip.

FIG. 10 illustrates another example of a trip route gadget 1040 that can be provided by the smart seeking module 336, as discussed above relative to FIG. 3, in accordance with certain embodiments. In the illustrated example, the trip route gadget 1040 graphically presents an interactive map showing changes in battery state of charge over the course of a trip. Further, in the illustrated example, the trip route gadget 1040 graphically presents map markers that indicate certain battery state of charge levels (e.g., one or more predetermined battery state of charge levels) during a trip. In certain aspects, the map markers shown in FIG. 10 can correspond to seek checkpoints in the recorded video, such that the map markers can be selected by users to jump to specific time entries with a single user input, in similar fashion to the map markers discussed relative to FIG. 8B.

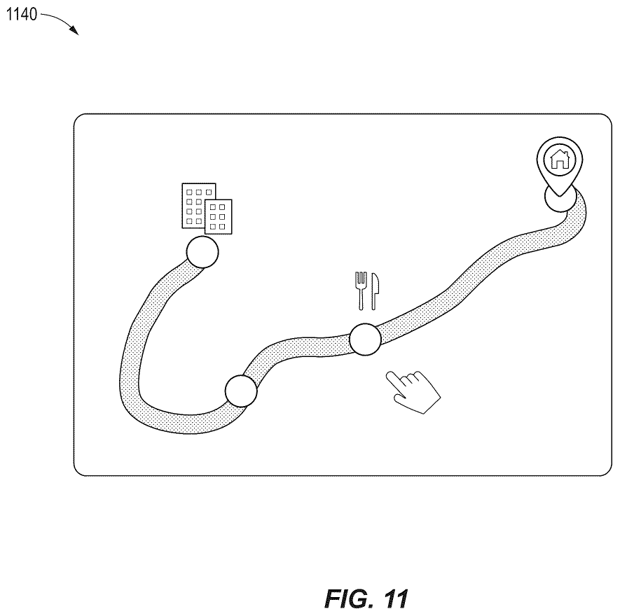

FIG. 11 illustrates another example of a trip route gadget 1140 that can be provided by the smart seeking module 336, as discussed above relative to FIG. 3, in accordance with certain embodiments. In the illustrated example, the trip route gadget 1140 graphically presents an interactive map display with map markers that indicate certain metadata such as POIs and notable stops. In certain aspects, the map markers shown in FIG. 11 can correspond to seek checkpoints in the recorded video, such that the map markers can be selected by users to jump to specific time entries with a single user input, in similar fashion to the map markers discussed relative to FIGS. 8B and 10.

In certain aspects, by transforming a trip route gadget into an active control mechanism, as shown by way of example relative to FIGS. 8A-B and 9-11, various embodiments alleviate the pain points associated with traditional video navigation methods. For example, compared to linear slider bars, such embodiments offer enhanced contextual information, such as landmarks, speed patterns or zones, and notable stops, providing users with valuable insights to aid in seeking out segments of interest within the video. Through this integration of navigation controls and contextual metadata visualization, these embodiments (e.g., including the trip route gadget) can improve a user experience, thereby making video playback more intuitive, efficient, and engaging for users.

In some aspects, a trip route gadget, such as the trip route gadgets shown relative to FIGS. 8A-B and 9-11, can enable a user to draw additional map markers to create additional seek checkpoints. According to these aspects, the additional map markers can thereafter be user-selected to jump to specific time entries with a single user input, in similar fashion to the map markers discussed relative to FIGS. 8B, 10, and 11.

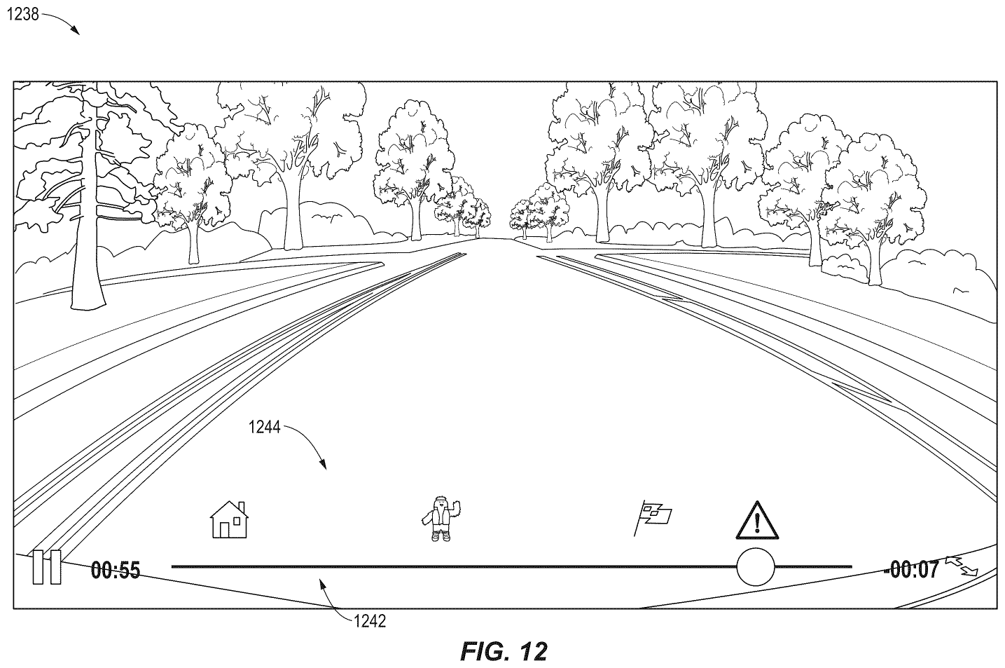

FIG. 12 illustrates an example of a display area 1238 including a seek bar 1242, in accordance with certain embodiments. The seek bar 1242 can include one or more outputs of the smart seeking module 336. In the example of FIG. 12, the seek bar 1242 includes a plurality of seek checkpoints 1244 that can correspond, for example, to any of the map markers, POIs, or other metadata discussed above, for example, relative to FIGS. 3, 7, 8A-B, and 9-11.

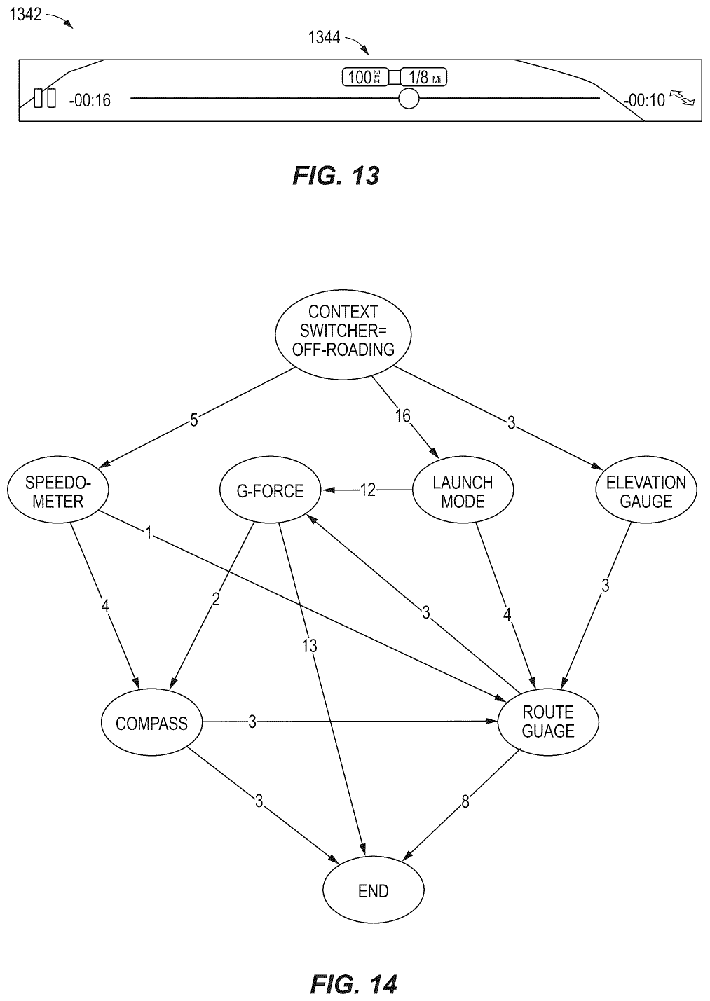

FIG. 13 illustrates an example of a seek bar 1342. The seek bar 1342 can include one or more outputs of the smart seeking module 336, in accordance with certain embodiments. In the example of FIG. 13, the seek bar 1342 includes a plurality of seek checkpoints 1344 that can corresponding, for example, to vehicle metadata such as a notable speed (e.g., a speed in excess of a predefined threshold of 100 mph) and a distance marker (e.g., a 1/8 mile marker). In various aspects, the seek bar 1342 similarly integrates, as seek checkpoints, any map markers, POIs, or other metadata discussed above, for example, relative to FIGS. 3, 7, 8A-B, and 9-11.

FIG. 14 illustrates an example of a nodal graph that can be created and updated by the self-learning recommendation engine 338, in accordance with certain embodiments. The nodal graph can be created and updated, for example, as discussed above relative to FIG. 3.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

While the foregoing is directed to embodiments of the present disclosure, other and further embodiments may be devised without departing from the basic scope thereof, and the scope thereof is determined by the claims that follow.

What is claimed is:

1. A method of dynamically integrating vehicle-generated video and metadata, the method comprising, by a computer system:
initiating playback of a video file in a display area, the video file comprising recorded video in association with vehicle metadata of a plurality of vehicle metadata types;
determining priorities of a plurality of visual gadgets responsive to the initiated playback, wherein the plurality of visual gadgets are each associated with at least one vehicle metadata type of the plurality of vehicle metadata types;
selecting a subset of the plurality of visual gadgets based on the determined priorities; and
causing the selected subset of the plurality of visual gadgets to be placed in the display area, each placed visual gadget of the subset graphically presenting at least a portion of the vehicle metadata of the associated at least one vehicle metadata type.

2. The method of claim 1, wherein the determining, the selecting, and the causing are performed iteratively during the playback of the video file.

3. The method of claim 2, wherein, for at least one iteration of the determining, the selecting, and the causing:
the determined priorities differ from the determined priorities for an immediately preceding iteration of the determining, the selecting, and the causing; and
the causing comprises swapping, in the display area, a first visual gadget of the plurality of visual gadgets for a second visual gadget of the plurality of visual gadgets responsive to the difference.

4. The method of claim 3, wherein the swapping is performed responsive to a determination that an amount of previous gadget swapping during at least a portion of the playback is less than a defined threshold.

5. The method of claim 2, wherein, for at least one iteration of the determining, the selecting, and the causing:
the selected subset is the same as the selected subset for an immediately preceding iteration of the determining, the selecting, and the causing; and
the causing comprises maintaining an existing placement of the selected subset in the display area.

6. The method of claim 1, wherein the causing comprises positioning the selected subset in in the display area based on the determined priorities.

7. The method of claim 1, wherein the determining priorities comprises calculating personal preference scores for the plurality of visual gadgets based on user preferences for the plurality of visual gadgets.

8. The method of claim 7, wherein the user preferences relate to visual gadget preferences within one or more vehicle modes.

9. The method of claim 7, wherein the personal preference scores are calculated based on a graph of the user preferences for the plurality of visual gadgets.

10. The method of claim 9, further comprising updating the graph based on observed user behavior relative to the plurality of visual gadgets.

11. The method of claim 1, wherein the determining priorities comprises calculating metadata freshness scores for the plurality of visual gadgets based on an amount by which metadata has changed over a predetermined interval of time.

12. The method of claim 1, wherein the determining priorities comprises calculating metadata contextual scores for the plurality of visual gadgets, wherein the metadata contextual scores indicate a current relevance of the plurality of visual gadgets based on contextual data.

13. The method of claim 1, further comprising updating the priorities based on one or more relationships between the plurality of visual gadgets for at least one vehicle mode.

14. The method of claim 1, wherein at least one visual gadget of the selected subset indicates a point of interest in the recorded video.

15. The method of claim 1, wherein at least one visual gadget of the selected subset graphically presents an interactive map display comprising a plurality of map markers, wherein the plurality of map markers correspond to a plurality of seek checkpoints in the recorded video.

16. The method of claim 15, wherein the interactive map display shows a speed pattern during a trip.

17. The method of claim 1, wherein at least one visual gadget of the selected subset graphically presents an interactive map display comprising a plurality of map markers indicative of a battery state of charge during a trip, wherein the plurality of map markers correspond to a plurality of seek checkpoints in the recorded video.

18. The method of claim 1, further comprising providing a seek bar comprising a plurality of seek checkpoints, the plurality of seek checkpoints corresponding to a plurality of map markers for a trip.

19. A system for dynamically integrating vehicle-generated video and metadata, the system comprising:
a memory comprising executable instructions;
a processor in communication with the memory and configured to execute the instructions to:
initiate playback of a video file in a display area, the video file comprising recorded video in association with vehicle metadata of a plurality of vehicle metadata types;
determine priorities of a plurality of visual gadgets responsive to the initiated playback, wherein the plurality of visual gadgets are each associated with at least one vehicle metadata type of the plurality of vehicle metadata types;
select a subset of the plurality of visual gadgets based on the determined priorities; and
cause the selected subset of the plurality of visual gadgets to be placed in the display area, each placed visual gadget of the subset graphically presenting at least a portion of the vehicle metadata of the associated at least one vehicle metadata type.

20. A computer-program product comprising a non-transitory computer-usable medium having computer-readable program code embodied therein, the computer-readable program code adapted to be executed to implement a method of dynamically integrating vehicle-generated video and metadata, the method comprising:
initiating playback of a video file in a display area, the video file comprising recorded video in association with vehicle metadata of a plurality of vehicle metadata types;
determining priorities of a plurality of visual gadgets responsive to the initiated playback, wherein the plurality of visual gadgets are each associated with at least one vehicle metadata type of the plurality of vehicle metadata types;
selecting a subset of the plurality of visual gadgets based on the determined priorities; and
causing the selected subset of the plurality of visual gadgets to be placed in the display area, each placed visual gadget of the subset graphically presenting at least a portion of the vehicle metadata of the associated at least one vehicle metadata type.
